(19) United States
(12) Patent Application Publication
(10) Pub. No.: US 2026/0186312 A1
(43) Pub. Date: Jul. 2, 2026

(54) ALL-FIBER LASER BEAM TUNING BY ADJUSTMENT OF ANGULAR INTENSITY DISTRIBUTION INCLUDING A LENS ARRAY

(71) Applicant: nLIGHT, Inc., Camas, WA (US)

(72) Inventors: Brendan G. O'DEA, Portland, OR (US); Juan Carlos LUGO, Vancouver, WA (US); Roger L. Farrow, Vancouver, WA (US)

(21) Appl. No.: 19/432,397

(22) Filed: Dec. 24, 2025

Related U.S. Application Data
(60) Provisional application No. 63/740,574, filed on Dec. 31, 2024.

(51) Int. Cl. G02B 27/09; G02B 6/028

(52) U.S. Cl. CPC G02B 27/0994; G02B 6/0281

(57) ABSTRACT

An optical beam delivery device includes at least first and second lengths of optical fiber that modify an angular intensity distribution of an input beam to generate an output beam with an adjustable near-field transverse spatial intensity distribution. The first length of optical fiber has a first refractive index profile (RIP) that produces a change in the angular distribution of a light beam. The second length of optical fiber having a step-index RIP that preserves a second angular distribution of the light beam. The first length of optical fiber includes a first GRIN fiber connected to a second GRIN fiber. The first GRIN fiber has a first pitch length of ½ pitch+n·pitch. The second GRIN fiber has a second pitch length of ¼ pitch+½n·pitch. A perturbation assembly alters the shape(s) of the first GRIN fiber and/or the second GRIN fiber.

### CROSS-REFERENCE TO RELATED APPLICATION(S)

This application relies on and claims priority benefit of U.S. Provisional Application No. 63/740,574, filed, Dec. 31, 2024, which is related to, but does not claim priority to, International Patent Application No. PCT/US2022/080460, filed on Nov. 23, 2022. Each application is hereby incorporated by reference in its entirety.

### FIELD OF THE INVENTION

The present invention involves fiber lasers and fiber-coupled lasers. More particularly, the disclosed technology relates to apparatuses and systems for adjusting a near-field transverse spatial intensity distribution at an output of a fiber laser or fiber-coupled laser including a lens array.

### DESCRIPTION OF THE RELATED ART

As described in U.S. Pat. No. 10,423,015 (hereinafter “the '025 patent”), titled “Adjustable Beam Characteristics,” and its related patents, nLIGHT, Inc. developed technology for varying beam properties by controlling a spatial intensity distribution of a laser beam, i.e., adjusting its near-field intensity distribution.

The '015 patent describes a fiber operable to provide a laser beam having variable beam characteristics (VBC) that may reduce cost, complexity, optical loss, or other drawbacks of the conventional methods. This VBC device is configured to vary a wide variety of optical beam characteristics. Such beam characteristics can be controlled using the VBC device thus allowing users to tune various beam characteristics to suit the particular requirements of an extensive variety of laser processing applications. For example, a VBC device may be used to tune: beam diameter, divergence distribution, BPP, intensity distribution, M2 factor, NA, optical intensity, power density, radial beam position, radiance, spot size, or the like, or any combination thereof.

In some embodiments, the '015 patent describes adjusting the coupling of the beam into a so-called ring fiber, which has two or more guiding regions. A ring fiber has one or more annular cores optionally surrounding a central (non-annular) core, with low-index glass layers separating the cores so that light coupled into a core will be guided in that core. The angular intensity distribution of the beam need not be directly controlled and depends on various factors such as the laser divergence, bending of the upstream optical fibers, and overlap of the near-field transverse spatial intensity distribution with the guiding confinement regions of the ring fiber.

To achieve a variety of beam diameters and shapes using embodiments and techniques described in the '015 patent, it is possible to divide the spatial intensity distribution of a laser beam coupled to a ring fiber between two or more guiding zones of the fiber. This approach causes a portion of the beam to overlap with the low-index region(s) separating the zones, resulting in increased divergence. This increased divergence is undesirable for some applications, e.g., it can cause overheating of some process optics.

International Patent Application No. PCT/US2022/080460 (hereinafter “the '460 application”), which is incorporated herein by reference, describes a variation of the apparatus discussed in the '015 patent by introducing, inter alia, a straight GRIN fiber.

One difficulty with the apparatus described in the '460 application lies in the fact that the GRIN fiber has a small focal length and, therefore, produces a small ring of output light.

### SUMMARY OF THE INVENTION

The present invention provides one or more advantages over the prior art.

Among the advantages, the present invention incorporates a lens array that permits the formation of a ring (or other shape) of output light that is larger than that possible using a GRIN fiber.

Specifically, the present invention provides an optical beam delivery device that includes multiple lengths of optical fiber arranged along an optical axis. The multiple lengths of optical fiber are configured to modify an angular intensity distribution of an input beam so that it is converted to an output beam having an adjustable near-field transverse spatial intensity distribution. The optical beam delivery device includes a first length of optical fiber with a first input and a first output, the first input being couplable to a source fiber and configured to receive therefrom the input beam that is azimuthally symmetric with respect to the optical axis. The first length of optical fiber has a first refractive index profile (RIP) configured to produce, in response to a controllable perturbation, a change in the angular distribution from a first angular distribution corresponding to the input beam to a second angular distribution corresponding to a modified beam at the first output. The second length of optical fiber includes a second input and a second output, the second input coupled to the first output of the first length of optical fiber and configured to receive therefrom the modified beam. The second length of optical fiber has a step-index RIP configured to preserve the second angular distribution and provide at the second output the modified beam with a preserved angular distribution. The first length of optical fiber comprises a first GRIN fiber connected to a second GRIN fiber. The first GRIN fiber has a first pitch length of ½ pitch+n·pitch, where n=an integer equal to or greater than 0. The second GRIN fiber has a second pitch length of ¼ pitch+½n·pitch, where n=an integer equal to or greater than 0. The optical beam delivery device also includes a perturbation assembly adapted to apply at least one of a first force to the first GRIN fiber to alter a first shape of the first GRIN fiber or a second force to the second GRIN fiber to alter a second shape of the second GRIN fiber.

In one contemplated embodiment of the optical beam delivery device, the perturbation assembly applies the first force to the first GRIN fiber only.

In another contemplated embodiment, the perturbation assembly applies the second force to the second GRIN fiber only.

Still further, it is contemplated that the perturbation assembly may apply the first force to the first GRIN fiber and the second force to the second GRIN fiber.

It is contemplated that the optical beam delivery device also may include a lens array disposed downstream of the second length of optical fiber, wherein the lens array has a focal length of between about 15-200 mm.

Where a lens array is provided, the lens array is contemplated to include at least one collimating lens.

In this contemplated embodiment, the at least one collimating lens may include at least one spherical lens.

Alternatively, the at least one collimating lens may encompass at least one aspherical lens.

It is also contemplated that the optical beam delivery device may be configured such that the second length of optical fiber is a step-index optical fiber segment having a length configured to azimuthally scramble the modified beam.

Still further, the optical beam delivery device may be configured to include a third GRIN fiber disposed downstream of the second length of optical fiber.

In a further contemplated embodiment, it is contemplated that the first GRIN fiber has a first pitch length with a smaller gradient constant than the second pitch length of the second GRIN fiber.

Other advantages of the present invention will be made apparent from the discussion that follows.

### BRIEF DESCRIPTION OF THE DRAWINGS

The present invention will now be described in connection with the drawings appended hereto, in which:

FIG. 1 is a side view of an optical beam delivery device according to a first embodiment of the present invention;

FIG. 2 is a beam propagation simulation plot (propagation direction is from left to right along a Z axis) for the embodiment of FIG. 1, showing a mode field in an X-Z plane as the beam propagates through the GRIN fiber;

FIG. 3 is a set of beam propagation simulation plots for the embodiment of FIG. 1, showing an adjustment of angular intensity distribution in an X-Y angle space (upper plot) and its corresponding beam profile (lower plot) at an output of the bendable ¼ pitch length of GRIN fiber when it is straight;

FIG. 4 is a set of beam propagation simulation plots for the embodiment of FIG. 1, showing an adjustment of angular intensity distribution in an X-Y angle space (upper plot) and its corresponding beam profile (lower plot) at an output of the bendable ¼ pitch length of GRIN fiber when it is bent;

FIG. 5 is a set of experimentally produced beam propagation plots for the embodiment of FIG. 1, showing an X-Y intensity distribution (upper plot) and its corresponding beam profile (lower plot) at an end of the step-index length of fiber when the bendable ¼ pitch length of GRIN fiber is straight;

FIG. 6 is a set of experimentally produced beam propagation plots for the embodiment of FIG. 1, showing an X-Y intensity distribution (upper plot) and its corresponding beam profile (lower plot) at an end of the step-index length of fiber when the bendable ¼ pitch length of GRIN fiber is bent;

FIG. 7 is a side view of an optical beam delivery device according to a second embodiment of the present invention;

FIG. 8 is a side view of an optical beam delivery device according to a third embodiment of the present invention;

FIG. 9 is a side view of an optical beam delivery device according to a fourth embodiment of the present invention;

FIG. 10 is a side view of an optical beam delivery device according to a fifth embodiment of the present invention; and

FIG. 11 is a side view of an optical beam delivery device according to a sixth embodiment of the present invention.

### DETAILED DESCRIPTION OF EMBODIMENT(S) OF THE INVENTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems and apparatuses described herein should not be construed as limiting in any way. Instead, the present disclosure is directed toward all novel and non-obvious features and aspects of the various disclosed embodiments, alone and in various combinations and sub-combinations with one another. The disclosed systems, methods, and/or apparatuses are not limited to any specific aspect or feature or combinations thereof, nor do the disclosed systems, methods, and/or apparatuses require that any one or more specific advantages be present, or problems be solved. Any theories of operation are to facilitate explanation, but the disclosed systems, methods, and/or apparatuses are not limited to such theories of operation.

Where applicable, the operations of some of the disclosed methods are described in a particular, sequential order for convenient presentation. It should be understood, however, that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other systems, methods, and apparatuses. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by skilled persons.

In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. Moreover, in the following examples, laser components and assemblies are described at a high level of abstraction and do not include a complete description of all mechanical, electrical, and optical elements necessary for operation.

In addition, various components and steps may be referred to as “first,” “second,” and “third,” etc. It is noted that the use of “first,” “second,” and “third” are intended to follow common grammatical practice and are note intended to infer any particular hierarchy unless otherwise indicated. Moreover, a component and/or step may be referred to as “first” in one instance and “second” in another instance to avoid grammatical irregularities.

As used herein, optical radiation refers to electromagnetic radiation at wavelengths of between about 100 nm and 10 μm, and typically between about 500 nm and 2 μm. Examples based on available laser diode sources and optical fibers generally are associated with wavelengths of between about 800 nm and 2,000 nm. In some examples, propagating optical radiation is referred to as one or more beams having diameters, asymmetric fast and slow axes, beam cross-sectional areas, and beam divergences that can depend on beam wavelength and the optical systems used for beam shaping. For convenience, optical radiation is referred to as light or beams in some examples and need not be at visible wavelengths. Forward-propagating light or optical beams or beam portions refer to light, beams, or beam portions that propagate in a direction of normal emission. Backward propagating light or optical beams or beam portions refer to light, beams, or beam portions that propagate in an opposite direction of normal emission.

To understand the characteristics of embodiments described in the present disclosure, it is helpful to first understand the underlying components and physical phenomena exploited with the components. Accordingly, the following paragraphs summarize optical fibers and lenses.

Optical fibers: An optical fiber is a thin, flexible strand of material (typically glass) that guides light within a core that is surrounded by a cladding. The core has a higher refractive index than the cladding, causing light to be guided by total internal reflection. The refractive index profile (RIP), i.e., the refractive index as a function of position transverse to the fiber axis, determines many of the important properties of the fiber. Many but not all fibers are cylindrically symmetric (i.e., the index is independent of azimuthal angle about the fiber axis). The optical fibers, therefore, may have circular, square, rectangular, polygonal, oval, elliptical, or other cross-sections. In some embodiments, the core and claddings are approximately concentric. In other examples, one or more of the core and claddings are decentered, and in some examples, core and cladding orientation and/or displacement vary along a waveguide length.

Optical fibers are typically formed of silica (glass) that is doped (or undoped) to provide predetermined RIPs. In some examples, fibers or other waveguides are made of other materials such as fluorozirconates, fluoroaluminates, fluoride or phosphate glasses, chalcogenide glasses, or crystalline materials such as sapphire, depending on wavelengths and other properties of interest. Refractive indices of silica and fluoride glasses are typically about 1.5, but refractive indices of other materials such as chalcogenides can be 3 or more. In still other examples, optical fibers can be formed in part or completely of plastics (polymers).

In some examples, a doped waveguide core such as a fiber core provides optical gain in response to pumping. In the examples disclosed herein, a waveguide core such as an optical fiber core is doped with a rare earth element such as Nd, Yb, Ho, Er, or other active dopants or combinations thereof. Such actively doped cores can provide optical gain in response to optical or other pumping. As disclosed below, waveguides having such active dopants can be used to form optical amplifiers, or, if provided with suitable optical feedback such as reflective layers, mirrors, Bragg gratings, or other feedback mechanisms, such waveguides can generate laser emissions. Optical pump radiation can be arranged to co-propagate and/or counter-propagate in the waveguide with respect to a propagation direction of an emitted laser beam or an amplified beam.

Step-index fibers: The most common RIP is known as “step index,” in which the core has a uniform index and is surrounded by the cladding with a uniform (lower) index. In a step-index fiber, light launched into the fiber core in a given location tends to spread radially and azimuthally to fill the core, i.e., the core does not preserve spatial information about the location of the launched beam. Light rays launched at a particular angle with respect to the fiber axis tend to exit the fiber core at the same angle (in a cone because of azimuthal scrambling), i.e., step-index fibers typically preserve angular information. In particular, the preservation of launch and the output angles (i.e., the far-field) is a property leveraged by embodiments of this disclosure. (Note that the terms far- and near-field intensity distribution mean, respectively, an angular intensity distribution (angular as with respect to the optical axis) and a transverse spatial intensity distribution.) Various effects can cause imperfect preservation of the launch angle (e.g., causing higher divergence for the output than the input rays), and multiple studies have investigated methods to minimize this effect.

GRIN fibers: Some fibers have a non-uniform RIP in the core and (less often) in the cladding. A common, non-uniform core RIP is known as “graded index” or “GRIN,” in which the index value decreases monotonically from the center of the core to the cladding. In many cases, the GRIN profile is parabolic. The size of a beam coupled into a parabolic GRIN fiber may oscillate periodically as the beam propagates along the fiber, with the oscillation period known as the “pitch” of the fiber. A parabolic GRIN fiber with an appropriate length can act as a lens that focuses or collimates a beam. This property is also used in free-space GRIN lenses, i.e., it is not limited to fibers.

Multi-clad fibers: Another example of a non-uniform RIP is a fiber with multiple claddings (“double-clad fiber,” “triple-clad fiber,” etc.). As with other non-uniform RIPs, propagation of light in a multi-clad fiber depends on the specific RIP and the launch conditions. Light launched into the highest-index guiding region may not spread into all the cladding regions, but light launched into a cladding layer will spread into all the higher index regions.

Multi-core fibers: Some fibers have multiple cores, i.e., multiple high-index guiding regions separated by surrounding low-index regions. The cores can have different sizes and shapes. Light launched into a given core will typically spread out to fill that core (as in a fiber with a single core) but will not spread into the other cores because the surrounding low-index region prevents propagation between the cores. Multi-core fibers are generally more expensive than more standard fibers, especially step-index fibers. The low-index regions separating the guiding regions generate highly divergent light if a portion of the beam is coupled into them. The downstream optics must be designed to accommodate this excess divergence, which typically adds cost, complexity, and/or optical loss (reduced efficiency). If not properly managed, the excess divergence can cause overheating or damage of the optics. The dimensions of the guiding regions are fixed when the fiber is manufactured. The beam dimensions thus cannot be continuously varied (although the power in each region can be continuously varied). Furthermore, if an application prefers different dimensions (e.g., a larger diameter ring), a new multi-core fiber must be fabricated, which can lead to a proliferation of product designs (which complicates and adds cost to manufacturing). Splicing of multi-core fibers in the factory and field is complicated by the need to align multiple guiding regions, which each have fabrication tolerances. Achieving the desired splicing performance can require excessively tight fiber tolerances (increasing cost), low splice yields, and/or performance degradation upon splicing (e.g., from coupling light into the low-index regions).

Note that the above discussion of the different types of optical fibers primarily pertains to multimode fibers, in which the ray picture of light propagation is accurate. Single-mode or near-single-mode fibers introduce other phenomena that are less relevant to the embodiments described in this disclosure.

Lenses: Lenses are ubiquitous in optical systems. A lens is conventionally thought of as a piece of glass with one or both surfaces curved, and the direction of propagation of a light ray is influenced by refraction at the surfaces. Other implementations of lenses are possible, including a GRIN lens (as mentioned above) in which the RIP of the material varies with radial position (rather than employing curved surfaces). The end of a fiber or an end cap attached to a fiber can have a curved surface to function as a lens. A design property of a lens is its focal length. A collimated input beam is focused to a point one focal length away from the lens (in the ray picture). Similarly, a point source located one focal length away from a lens is collimated at the lens output. Stated more generally, a lens maps between position and angle, i.e., a lens converts the angle of a ray at the input focal plane to position at the output focal plane, and it converts the input position of a ray at the input focal plane to angle at the output focal plane.

As detailed hereinbelow, without limitation, the present invention is presented as an improvement to the optical beam delivery device discussed in International PCT Patent Application No. PCT/US2022/080460 (hereinafter “the '460 Application”). Accordingly, much of the discussion provided in the '460 Application is applicable to the discussion herein.

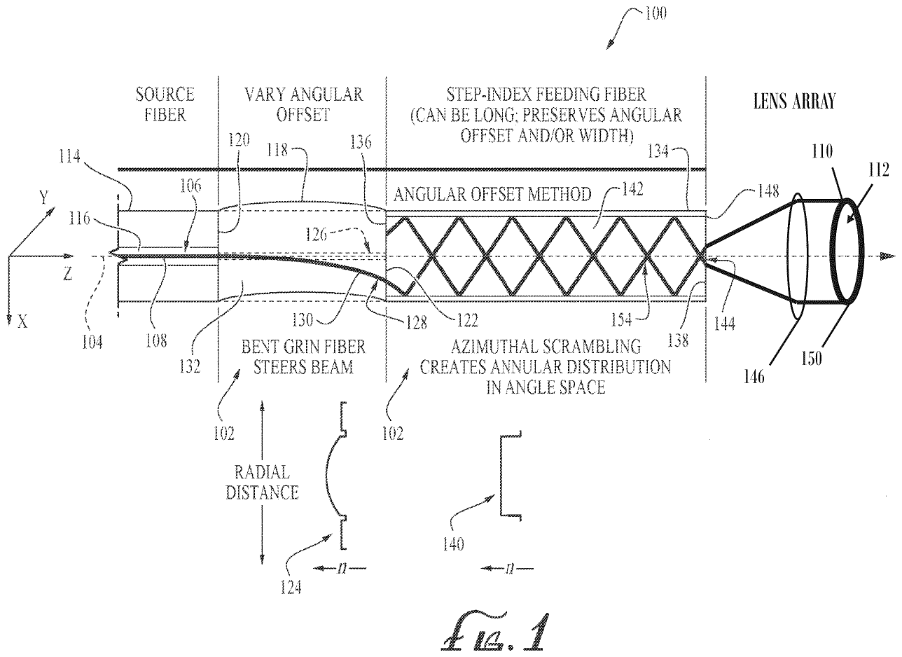

FIG. 1 is a graphical illustration of an optical beam delivery device 100 according to a first embodiment of the present invention.

In the illustrated embodiment, the optical beam delivery device 100 combines two lengths of optical fiber 102 that are disposed along an optical axis 104. A larger or smaller number of lengths of optical fiber 102 may be employed without departing from the scope of the present invention.

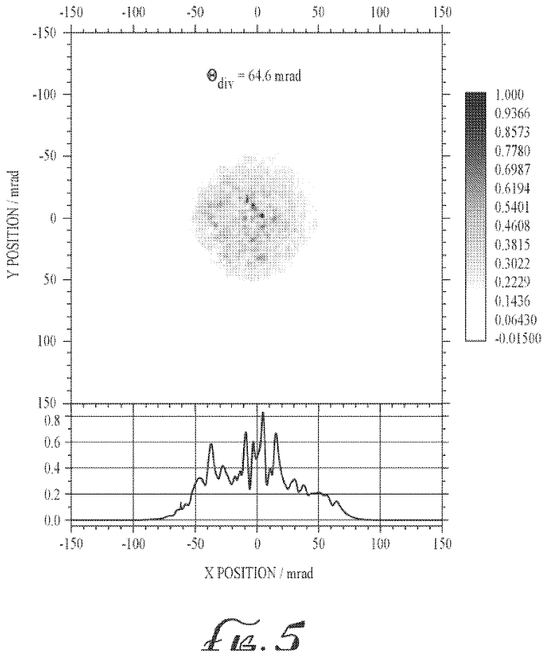

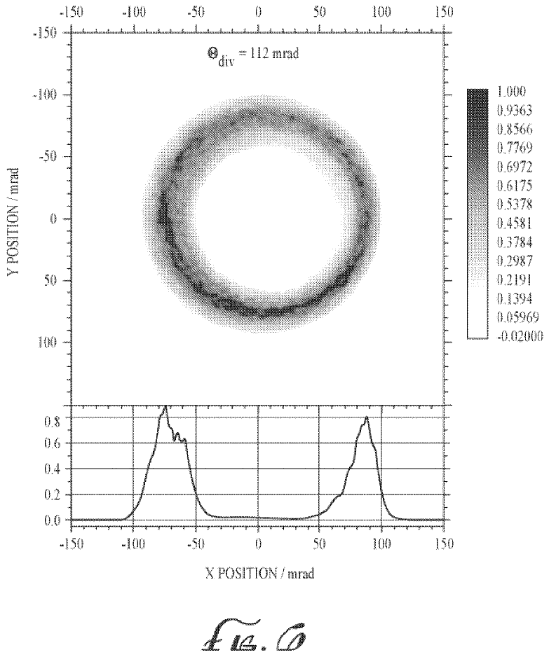

The optical fibers 102 modify an angular intensity distribution 106 of an input beam 108 so that it is converted to an output beam 110 having an adjustable near-field transverse spatial intensity distribution 112. In other words, the near-field transverse spatial intensity distribution is adjustable between Gaussian (see, e.g., FIG. 5) and ring (see e.g., FIG. 6) shaped output beams, at least in selected, non-limiting embodiments.

In the embodiment of FIG. 1, the input beam 108 is delivered from a source fiber 114 having a step-index core 116. In other embodiments, a source fiber is a ring fiber (e.g., one or more annular cores surrounding an optional central core), and the ring fiber may be a component of a VBC device described in the '015 patent. The term source fiber is any fiber (feeding or process) providing an input beam and that is fiber coupled (e.g., spliced) to an image relay fiber assembly. The term fiber coupled (or couplable) includes a direct physical connection as well as connections that are slightly spaced apart, i.e., at or within one Rayleigh range, which is the distance along the propagation direction of a beam from the waist to the place where the area of the cross section is doubled.

The source fiber 114 is spliced to a first length of the optical fiber 118, which has a first input 120 and a first output 122. Thus, the first input 120 is coupled to the source fiber 114 and is configured to receive therefrom the input beam 108 that is azimuthally symmetric with respect to the optical axis 104.

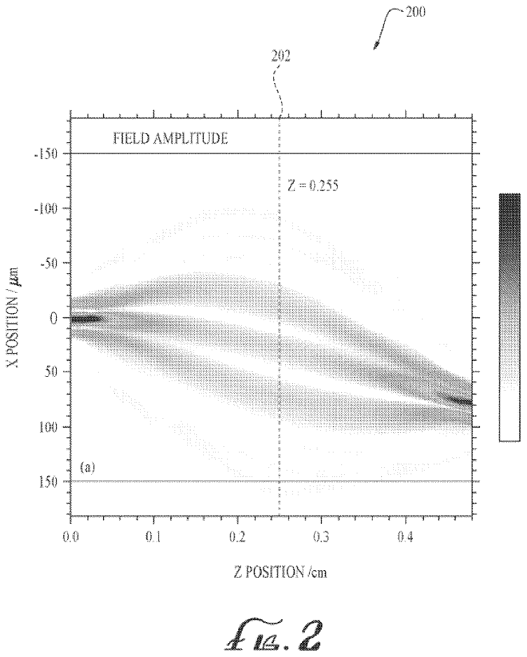

The first length of optical fiber 118 has a first RIP 124. The first RIP 124 is configured to produce, in response to a controllable perturbation (see, e.g, bending shown in FIG. 2), a change in angular intensity distribution 106 from a first angular intensity distribution 126 corresponding to input beam 108 to a second angular intensity distribution 128 corresponding to a modified beam 130 at the first output 122. Other examples of controllable perturbation devices are shown in FIG. 24 of the '105 patent.

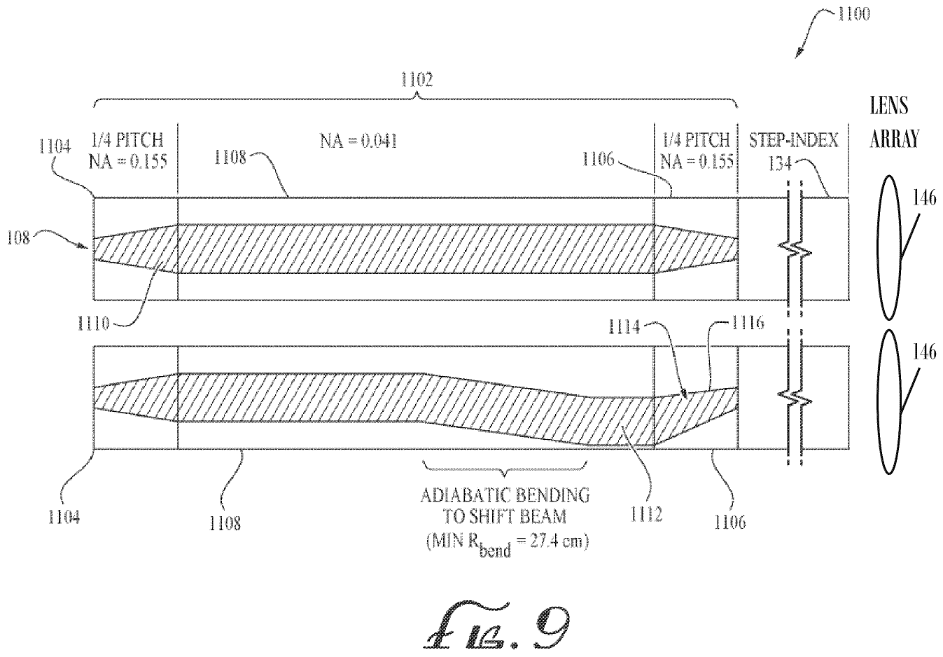

In the example of FIG. 1, the first length of optical fiber 118 is a relatively short (e.g., less than 10 mm) GRIN fiber having a ¼-pitch length. At this length, the input beam 108 beam reaches its maximum diameter, which is less than a 300 μm diameter GRIN core 132 in some embodiments. In other embodiments, an initial GRIN optical fiber segment may have a length of about ¼-pitch+n*½ pitch, where n is any positive integer and includes zero. Other lengths are also possible, depending on the desired application (see, e.g., FIG. 9). In a GRIN fiber, light rays transmit along sinusoidal paths. The length of fiber corresponding to one sine wave period is called the pitch, defined as follows:

$$p = \frac{2 π}{√ k} ,$$

where p is the pitch and k is the gradient constant determined by the refractive index profile of the GRIN fiber. The refractive index profile, n(r), of the GRIN fiber is defined as set forth in W. J. Smith, Modem Optical Engineering, Third Edition, McGraw-Hill, Inc. (2000), p. 286:

$$n ( r ) = {n}_{0} ( 1 - ( \frac{k}{2} ) {r}^{2} ) ,$$

where n₀ is the axial refractive index of the GRIN fiber, k is the gradient constant determined by the refractive index profile of the GRIN fiber, and r is the radius of the fiber.

In some embodiments, the first length of the optical fiber 118 and an initial section of a second length of optical fiber 134 are bent a variable amount (or not at all) around a mandrel (not shown) or other perturbation device shown and described in FIG. 24 of the '015 patent.

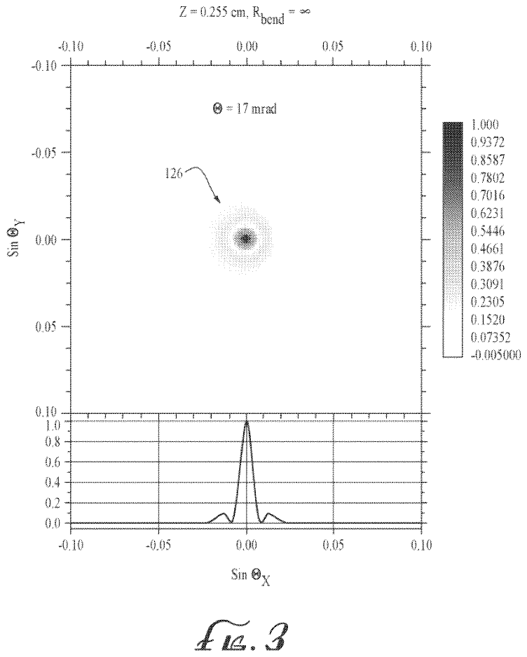

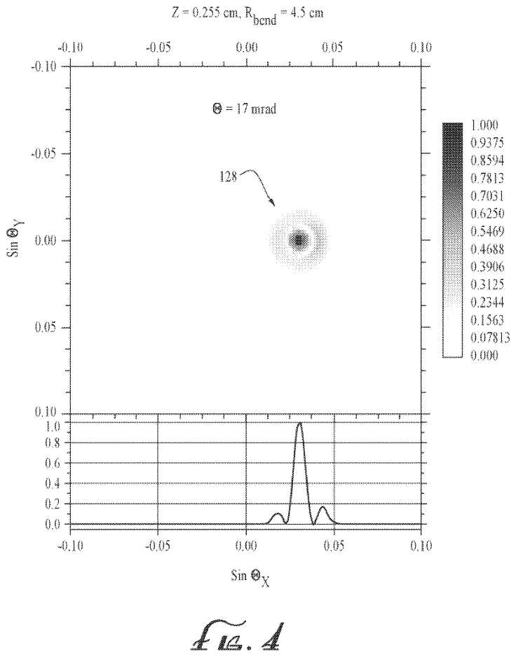

The angular intensity distribution 106 of the input beam 108 beam is varied by changing its angular offset without necessarily affecting its width. For instance, the first angular intensity distribution 126 has negligible angular offset with respect to optical axis 104 (see, e.g., FIG. 3) when the first length of the optical fiber 118 is not perturbed (i.e., straight, as indicated by dashed lines on first length of the optical fiber 118) whereas the second angular intensity distribution 128 includes a relatively large angular offset (see, e.g., FIG. 4) when the first length of the optical fiber 118 is perturbed (e.g., bent, as indicated in FIG. 1).

The second length of optical fiber 134, which includes a second input 136 and a second output 138, is coupled to the first output 122 and is configured to receive therefrom the modified beam 130. The second length of optical fiber 134 has a step-index RIP 140 configured to preserve a second angular intensity distribution 128. The modified beam 130 enters a step-index fiber core 142 (e.g., core diameter of 300 μm) and propagates while substantially preserving the angular offset with respect to the optical axis 104. The second angular intensity distribution 128 is preserved, i.e., its ray angles relative to the optical axis 104 (i.e., the fiber core) remain substantially constant from the second input 136 to the second output 138. Although it is largely preserved, for purposes of clarity (and recognizing that there may be some minor variation in the distributions), this disclosure refers to the second angular intensity distribution 128 at the second output 138 as a preserved angular intensity distribution 144.

In some embodiments, the second length of optical fiber 134 may be about five meters to about 50 meters long so as to transport the modified beam 130 a significant distance from the source (e.g., to a processing head or tool). As the modified beam 130 travels through the second length of optical fiber 134, the second angular intensity distribution 128 is azimuthally averaged (i.e., smoothed or symmetrized) due to normal routing (coiling or bending) of this delivery fiber. Thus, phi ray angles (azimuthal) are assumed to be scrambled in second length of the optical fiber 134. The angular width of the input beam 108 results from rays having slightly different angles. These rays take different paths (generally helical) and end up being scrambled azimuthally (cylindrically symmetric, phi invariant), although for simplicity FIG. 2 shows only two paths.

Finally, FIG. 1 shows a lens array 146 having a third input 148 and a third output 150. The third input 148 is coupled to and/or adjacent to the second output 138 and is configured to receive therefrom the modified beam 130 having preserved angular intensity distribution 144.

The lens array 146 generates, at the third output 150, the output beam 110 having adjustable near-field transverse spatial intensity distribution 112 corresponding to preserved angular intensity distribution 144 of modified beam 130. In some embodiments, output beam 110 at third output 150 is ring shaped. The diameter of the ring may be determined by the input angular offset and the thickness of the ring by the input divergence width. In other embodiments, the lens array 146 is contemplated to alter the near-field transverse spatial intensity distribution 112 as required or as desired.

It is noted that, while the third output 150 is ring shaped, the present invention is not limited to arrangements that generate solely a ring shaped third output 150.

The lens array 146 may be indirect contact with the second output 138 of the second length of optical fiber 134. Alternatively, a gap (e.g., an air gap) may persist between the second output 138 of the second length of the optical fiber 134 and the lens array 146.

It is contemplated that the lens array 146 will comprise a collimating lens and/or group of collimating lenses. Here, it is contemplated that the end of the second length of optical fiber 134 (e.g., the second output 138) may be positioned at the focal point of the lens array 146 so that the light emerging from the lens array 146 is a collimated beam.

The lens and/or lenses making up the lens array 146 may be of any type known to those skilled in the art. For example, the lens array 146 may include a single, aspherical lens, possibly with a complex surface. In another example, the lens array 146 may include a doublet, which may encompass two spherical lenses. In still another contemplated embodiment, the lens array 146 comprises a triplet, which may include three spherical lenses. Still further, it is contemplated that the lens array 146 may encompass a singlet, which encompasses a single spherical lens. Aspherical lenses also may be employed without departing from the scope of the present invention.

The lens array 146 is contemplated to offer advantages over a GRIN fiber, as discussed by the '460 application. In particular, GRIN fibers have a small focal length. As such, in the instance where the output light pattern is focused as a ring, for example (see, e.g., FIG. 6), the ring (e.g., the third output 150) will have a small diameter.

The lens array 146 permits magnification of the pattern of the output light (e.g., the third output 150). It is contemplated, for example, that the output light pattern (e.g., the third output 150) may be magnified up to 100× the original pattern size exiting from the second length of optical fiber 134.

To this end, it is contemplated that the focal length offered by the lens array 146 is 15-200 mm. This range is considerably greater than the focal length of the GRIN fiber described by the '460 application, which is on the order of 1 mm. In one other contemplated embodiment, the focal length of the lens array 146 is 20-150 mm. In other contemplated embodiments, the focal length of the lens array is one of 50 mm±10 mm, 100 mm±10 mm, 150 mm±10 mm, and 200 mm±10 mm.

FIG. 2 shows a simulated implementation of the angular offset technique shown and described previously with reference to FIG. 1.

Specifically, FIG. 2 shows, in an X-Z plane, an LP02 mode field 200 of the input beam 108 as it propagates through the first length of the optical fiber 118 along the Z-axis direction from the first input 120. The LP02 mode field 200 is shown as the first length of optical fiber 118 is subjected to a decreasing bend radius. “Field amplitude” refers to the light distribution, which is showing the field amplitude |E| as opposed to field intensity |E|².

The bottom axis of FIG. 2 shows that propagation is simulated through a distance of a ½ GRIN pitch length, with a ¼ GRIN pitch length 202 (Z=0.255 cm) indicated by a vertical dashed line. As described previously, the first length of the optical fiber 118 could be cut and spliced to the second input 136 of the second length of the optical fiber 134 at the ¼ GRIN pitch length 202 or at other desired lengths.

Through simulations, GRIN pitch, fiber length, and bending profile may be tailored to achieve a desired angular offset of the input beam 108 with a minimal change in divergence. For example, to maximize angular offset without increasing divergence, a specific length of GRIN fiber could be used as the first length of the optical fiber 118 and subjected to bending to create a desired angular offset. The pitch of the GRIN fiber may be selected to increase the beam diameter, thus lowering its divergence width and maximizing the ratio between angular offset and width. Specifically, for a given input beam divergence and spot size, a focal length of a ¼-pitch GRIN fiber may be chosen to decrease the divergence of the beam exiting the GRIN fiber.

FIG. 3 and FIG. 4 provide a comparison at 0.255 cm (¼ pitch length) between the first angular intensity distribution 126 and the second angular intensity distribution 128 shown, respectively, without bending and with bending of the first length of the optical fiber 118. Specifically, FIG. 4 shows that, with bending, the second angular intensity distribution 128 is transversely shifted in the bend plane by about 30 mrad, which is much greater than the divergence width of about 17 mrad.

FIG. 5 and FIG. 6 show results of an experiment employing a GRIN fiber having a larger pitch than the one used in the aforementioned simulations. Spliced onto the GRIN fiber is a step-index fiber. An intensity distribution of FIG. 5 shows a smaller diameter beam is formed without bending. In contrast, a ring-shaped beam is formed at the output of a spliced-on step-index fiber when the GRIN fiber is bent, as illustrated in FIG. 6.

FIG. 6 also shows that the second angular intensity distribution 128 is circularized by propagation in second length of optical fiber 134, but the angle with the Z axis is preserved.

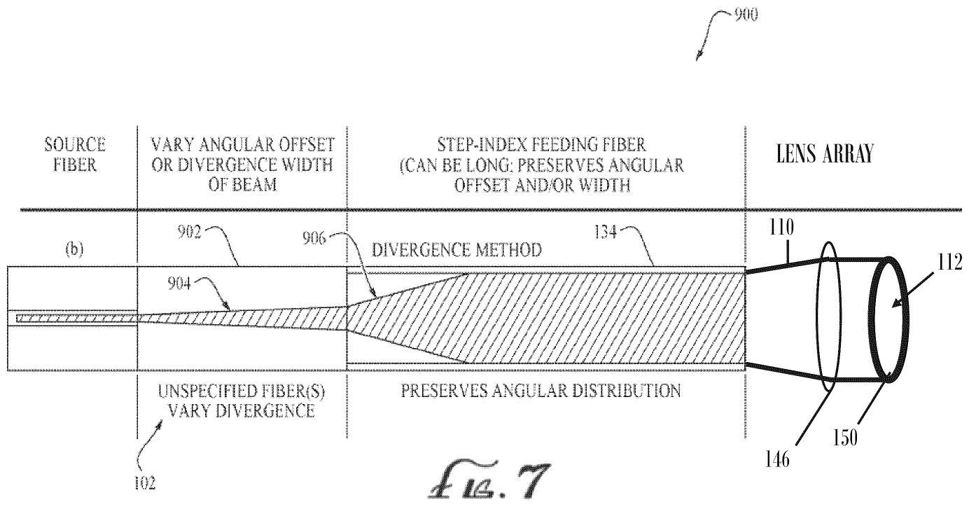

FIG. 7 shows an optical beam delivery device 900, according a second embodiment (referred to as an angular width/divergence embodiment). Like optical beam delivery device 100, optical beam delivery device 900 includes at least one length of optical fiber 102 to convert changes in angular intensity distribution to changes in near-field transverse spatial intensity distribution. But instead of having first length of optical fiber 118 configured to change the angular offset of input beam 108, the optical beam delivery device 900 includes a first length of optical fiber 902 that is configured to change a width of an angular intensity distribution 904 in response to a controllable perturbation. As described previously, a modified beam 906 enters second length of optical fiber 134 (a step-index fiber) and propagates while preserving the angular distribution.

As in the prior embodiment, the output from the second length of optical fiber 134 is provided to the lens array 146.

Those skilled in the art will appreciate that various techniques and fibers may be used to increase divergence in response to perturbation of first length of the optical fiber 902. For example, the first length of the optical fiber 902 may be a step-index fiber configured to respond to a non-adiabatic microbend (see, e.g., micro-bend 2404 in FIG. 24 of the '015 patent).

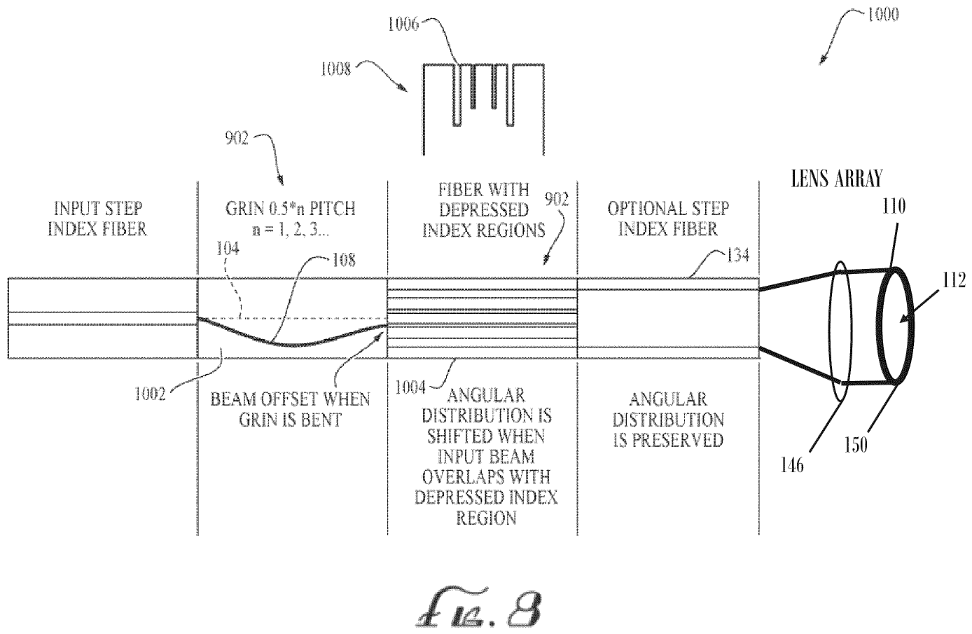

In another embodiment, FIG. 8 shows an optical beam delivery device 1000 in which first length of optical fiber 902 includes a first portion 1002 and a second portion 1004 coupled to first portion 1002. First portion 1002 includes a GRIN optical fiber segment having a length of about N*½ pitch, where N is any positive integer. Other lengths are also possible, depending on the design, but the length of about N*½ pitch facilitates interaction of the beam with low-index divergence structures 1006 in second portion 1004. The divergence structures 1006 (shown in RIP 1008) are designed to increase divergence. When the first portion 1002 is perturbed, the input beam 108 is displaced from optical axis 104 so that it is incident upon at least one of divergence structures 1006, which increases divergence to provide a modified beam to the second length of the optical fiber 134. Other examples of divergence structures are shown in FIG. 20 and FIG. 21 of the '015 patent.

Here again, the output from the second length of optical fiber 134 is provided to the lens array 146.

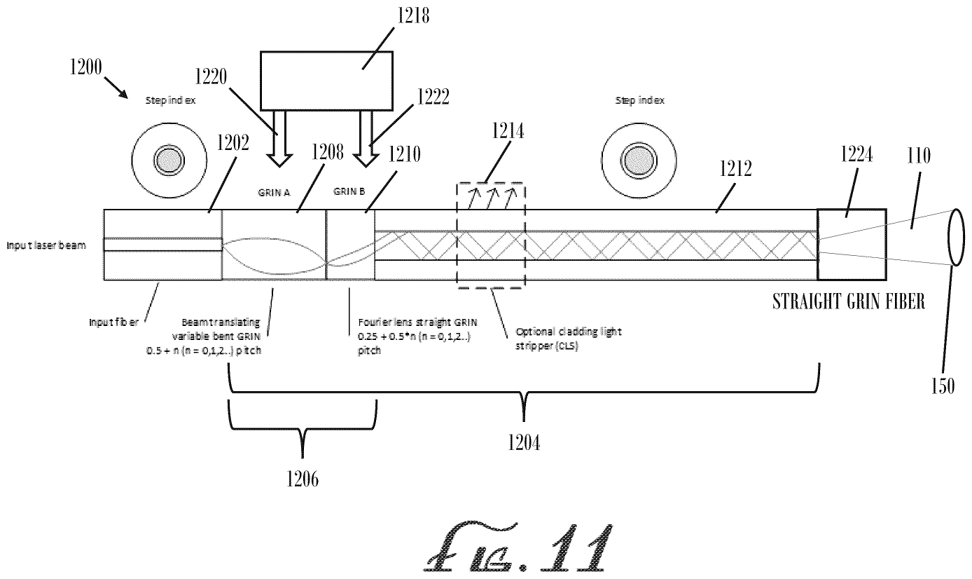

FIG. 9 shows another embodiment of an optical beam delivery device 1100, which includes a first length of fiber 1102 having an input GRIN portion 1104, an output GRIN portion 1106, and a central GRIN portion 1108 therebetween. The input GRIN portion 1104 is configured to collimate input beam 108 to provide a collimated beam 1110. The central GRIN portion 1108 is configured to shift the collimated beam 1110 in response to controllable perturbation (e.g., bending, as shown in bottom diagram of FIG. 11) so as to provide a shifted beam 1112. The output GRIN portion 1106 is configured to focus the shifted beam 1112 to provide modified beam 130 having an angular offset 1114 that is different from that of the input beam 108.

Those skilled in the art will appreciate in light of this disclosure that both the optical beam delivery device 1100 and the optical beam delivery device 100 (FIG. 1) act to vary an angular offset that is delivered to the second length of optical fiber 134. Furthermore, the optical beam delivery device 1100 may be modified to also vary divergence. For instance, by employing different NAs for the input GRIN portion 1104 and the output GRIN portion 1106, the angular width (divergence angle) may also be tuned. The input GRIN portion 1104 and the output GRIN portion 1106 are each shown as having ¼-pitch length, but other lengths are also possible. The effective focal length of these segments may be designed to provide different divergences of the modified beam 130 or to change other beam properties to accommodate the desired use case. In contrast to ¼- or ½-pitch lengths described previously for the first length of optical fiber 118 (FIG. 1), the optical beam delivery device 1100 also provides an example of how the first length of fiber 1102 may have varied lengths for different applications.

As before, the output from the second length of optical fiber 134 is provided to the lens array 146.

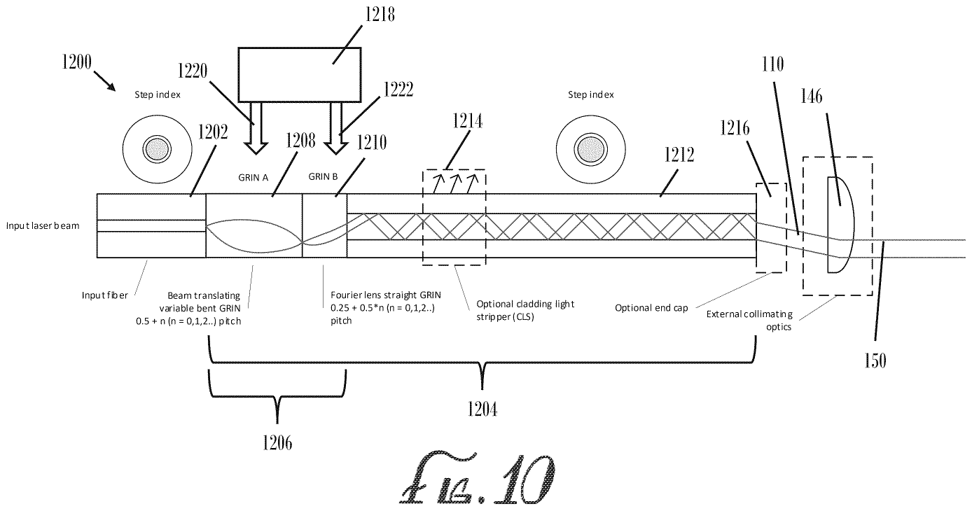

FIG. 10 shows another embodiment of an optical beam delivery device 1200. The input delivery device 1200 is connected to a laser beam input fiber 1202. The optical beam delivery device 1200 includes a first length of fiber 1204 having an input GRIN portion 1206. The GRIN portion 1206 includes a first GRIN fiber 1208 (labeled as “GRIN A”) coupled to a second GRIN fiber 1210 (labeled as “GRIN B”). The first GRIN fiber 1208 is a ½-pitch length fiber. The second GRIN fiber 1210 is a ¼-pitch length fiber. The second GRIN fiber 1210 is connected to a step index fiber 1212.

With reference to the first GRIN fiber 1208, the first GRIN fiber 1208 is contemplated to have a first pitch length of ½ pitch+n·pitch, where n=an integer equal to or greater than 0. More commonly, the first GRIN fiber 1208 is referred to as a ½-pitch length fiber. The second GRIN fiber 1210 is contemplated to have a second pitch length of ¼ pitch+½n·pitch, where n=an integer equal to or greater than 0. The second GRIN fiber 1210 is more commonly referred to as a ¼-pitch length fiber. In one contemplated embodiment, the integer n for the first GRIN fiber 1208 and the second GRIN fiber 1210 is 0. However, any positive integer n greater than or equal to 0 may be employed without departing from the scope of the present invention.

In one contemplated embodiment, the first GRIN fiber has a first length with a smaller gradient constant than the second length of second GRIN fiber. Still other configurations are contemplated to fall within the scope of the present invention, as should be apparent to those skilled in the art.

The step index fiber 1212 optionally includes a cladding light stripper (“CLS”) 1214. The output light from the step index fiber 1212 optionally passes through an optional end cap 1216. The light exiting the optional end cap 1216 may then pass through a lens array 146 as discussed hereinabove to generate the output beam 110.

As should be apparent from the foregoing, the beam delivery device, such as the beam delivery device 100 discussed in the '460 application, provides variable control over the intensity of the output light 150. This includes shaping the output light 150 as a ring, for example.

For the beam delivery device 1200, the arrangement of components provides for a variable angular (or divergence) profile for the output light 150, among other differences and/or advantages. Here, for example, the beam delivery device 1200 is capable of producing a larger or smaller ring of light as the output light 150. Another way of describing this is that the beam delivery device 1200 permits control over the cone of light, so that the cone may be larger or smaller. This depends, at least in part, on the angle of the output beam 110 from the step index fiber 1212, as illustrated.

As should be apparent from the foregoing, it is contemplated that the output beam may have a ring shaped, top hat shaped, or gaussian shaped profile. The inclusion of the first GRIN fiber 1208 and the second GRIN fiber 1210 permits control over the angular distribution of the output light 110 exiting from the step index fiber 1212. Specifically, the combination of the first GRIN fiber 1208 and the second GRIN fiber 1210 steers the angle of the light at the output from the step index fiber 1212.

It is contemplated that, if the first GRIN fiber 1208 and the second GRIN fiber 1210 provide no angular divergence for the output light 110, the output light 110 may have a gaussian shape. However, if the first GRIN fiber 1208 and the second GRIN fiber 1210 alter the angular divergence, the output light 110 will have a ring shape. The size and shape of the ring will depend on the amount of angular divergence introduced by the first GRIN fiber 1208 and the second GRIN fiber 1210.

The output light 110 may be provided, as discussed above, to the lens array 146 to change the magnification of the output light 110 to generate the collimated output light 150.

To create the angular divergence by the first GRIN fiber 1208 and the second GRIN fiber 1210, it is contemplated that the first GRIN fiber 1208 and the second GRIN fiber 1210 will be bent or otherwise manipulated. By bending or manipulating the first GRIN fiber 1208 and the second GRIN fiber 1210, the shape or shapes of one or both of the first GRIN fiber 1208 and the second GRIN fiber 1210 may be changed. The change in shape of one or both of the first GRIN fiber 1208 and the second GRIN fiber 1210 alters the angular divergence of the light passing therethrough. As a result, the angular divergence of the output light 110 may be altered by changing the shape of one or both of the first GRIN fiber 1208 and the second GRIN fiber 1210.

In one contemplated embodiment, only the shape of the first GRIN fiber 1208 is altered. When the first GRIN fiber 1208 is bent, this creates a positional offset of the light. The positional offset is then translated into an angular offset by at least the second GRN fiber 1210.

To alter the shape of the first GRIN fiber 1208 and/or the second GRIN fiber 1210, a perturbation assembly 1218 is disposed in proximity to the first GRIN fiber 1208 and the second GRIN fiber 1210. The perturbation assembly 1218 applies a force to one or both of the first GRIN fiber 1208 and the second GRIN fiber 1210 as indicated by the arrows 1220, 1222. Specifically, as shown, a first force 1220 is applied to the first GRIN fiber 1208. A second force 1222 is applied to the second GRIN fiber 1210.

The perturbation assembly 1218 may be any type of device including, but not limited to, a dowel, mandrel, press, or the like, that presses on the first GRIN fiber 1208 and/or the second GRIN fiber 1210. By pressing on the first GRIN fiber 1208, for example, the positional offset in the light is established. As noted, this positional offset translates into an angular offset in the output light 110 generated by the beam delivery device 1200.

FIG. 11 shows another embodiment of an optical beam delivery device 1300 according to the present invention.

This embodiment is similar to the optical beam delivery device 1200. Here, a third GRIN fiber 1224, which may be a straight GRIN fiber is connected downstream of the step index fiber 1212. The third GRIN fiber 1224 produces the output light 110, 150 as discussed in connection with other embodiments. Details of the third GRIN fiber 1224 may be either one of a ½-pitch length fiber or a ¼-pitch length fiber as discussed hereinabove. Specifically, the third GRIN fiber 1224 may be a ½-pitch length fiber with characteristics akin to the characteristics discussed in connection with the first GRIN fiber 1208. Alternatively, the third GRIN fiber 1224 may be a ¼-pitch length fiber with the parameters discussed in connection with the second GRIN fiber 1210.

Having described and illustrated the general principles of examples of the presently disclosed technology, it should be apparent that the examples may be modified in arrangement and detail without departing from such principles. Those skilled in the art, therefore, will appreciate that many changes may be made to the details of the above-described embodiments without departing from the underlying principles of the invention. The scope of the present invention should, therefore, be determined only by the following claims.

What is claimed is:

1. An optical beam delivery device including multiple lengths of optical fiber arranged along an optical axis, the multiple lengths of optical fiber being configured to modify an angular intensity distribution of an input beam so that it is converted to an output beam having an adjustable near-field transverse spatial intensity distribution, the optical beam delivery device comprising:
a first length of optical fiber including a first input and a first output, the first input being couplable to a source fiber and configured to receive therefrom the input beam that is azimuthally symmetric with respect to the optical axis, the first length of optical fiber having a first refractive index profile (RIP) configured to produce, in response to a controllable perturbation, a change in the angular distribution from a first angular distribution corresponding to the input beam to a second angular distribution corresponding to a modified beam at the first output;
a second length of optical fiber including a second input and a second output, the second input coupled to the first output of the first length of optical fiber and configured to receive therefrom the modified beam, the second length of optical fiber having a step-index RIP configured to preserve the second angular distribution and provide at the second output the modified beam with a preserved angular distribution,
wherein the first length of optical fiber comprises a first GRIN fiber connected to a second GRIN fiber,
wherein the first GRIN fiber has a first pitch length of ½ pitch+n·pitch, where n=an integer equal to or greater than 0, and
wherein the second GRIN fiber has a second pitch length of ¼ pitch+½n·pitch, where n =an integer equal to or greater than 0; and
a perturbation assembly adapted to apply at least one of a first force to the first GRIN fiber to alter a first shape of the first GRIN fiber or a second force to the second GRIN fiber to alter a second shape of the second GRIN fiber.

2. The optical beam delivery device of claim 1, wherein the perturbation assembly applies the first force to the first GRIN fiber only.

3. The optical beam delivery device of claim 1, wherein the perturbation assembly applies the second force to the second GRIN fiber only.

4. The optical beam delivery device of claim 1, wherein the perturbation assembly applies the first force to the first GRIN fiber and the second force to the second GRIN fiber.

5. The optical beam delivery device according to claim 1, further comprising:
a lens array disposed downstream of the second length of optical fiber, wherein the lens array has a focal length of between about 15-200 mm.

6. The optical beam delivery device of claim 5, wherein the lens array comprises at least one collimating lens.

7. The optical beam delivery device of claim 6, wherein the at least one collimating lens comprises at least one spherical lens.

8. The optical beam delivery device of claim 6, wherein the at least one collimating lens comprises at least one aspherical lens.

9. The optical beam delivery device of claim 1, wherein the second length of optical fiber is a step-index optical fiber segment having a length configured to azimuthally scramble the modified beam.

10. The optical beam delivery device according to claim 1, further comprising:
a third GRIN fiber disposed downstream of the second length of optical fiber.

11. The optical beam delivery device of claim 1, wherein the first GRIN fiber has a first pitch length with a smaller gradient constant than the second pitch length of the second GRIN fiber.
